(19) United States
(12) Patent Application Publication
(10) Pub. No.: US 2007/0262900 A1
(43) Pub. Date: Nov. 15, 2007

(54) METHOD AND SYSTEM OF IMPROVING TIME TO FIRST FIX IN A SATELLITE POSITIONING SYSTEM

(75) Inventors: KRISTI A. HAVERKAMP, CHANDLER, AZ (US); KEITH M. KLUG, MESA, AZ (US)

Correspondence Address: AKERMAN SENTERFITT, P.O. BOX 3188, WEST PALM BEACH, FL, 33402-3188, US

(73) Assignee: MOTOROLA, INC., SCHAUMBURG, IL (US)

(21) Appl. No.: 11/382,993

(22) Filed: May 12, 2006

(51) Int. Cl. G01S 5/14

(52) U.S. Cl. 342/357.15

(57) ABSTRACT

A satellite positioning system (SPS) antenna aiding device (100) includes an SPS receiver (102), an environmental sensor (106) to determine a heading value, a tilt value, or an acceleration value, and a processor (104). The processor can be programmed to determine (306) heading, determine (304) an estimated direction of peak antenna gain in relation to satellites in view, and prioritize (308) acquisition attempts of a portion of satellites in view based on the estimated direction of peak antenna gain and environmental data. The processor can perform (310) a split search with correlators split between searches for satellites with assumed peak gain using a shorter dwell time and longer dwell time searches for satellites with lower gain. The device can electronically present (312) an orientation guide to a user based on the estimated direction of peak antenna gain and in view of the heading of the SPS receiver.

### FIELD

This invention relates generally to satellite positioning systems, and more particularly to a method and system improving satellite acquisition.

### BACKGROUND

In typical GPS applications in a mobile handheld device, antenna orientation is unknown and there are no optimization parameters available to the GPS search engine to account for antenna properties that are known to the product designer for a fixed antenna orientation.

Some existing systems use compass and accelerometers to determine unit orientation relative to a mapping of a calibration of RSSI from base stations where signal strength is used in position determination. Such systems fail to use GPS as a method of position determination.

### SUMMARY

Embodiments in accordance with the present invention can provide location fixes far more quickly when heading information about the user's current orientation is incorporated as part of an antenna aiding algorithm to a SPS or GPS search engine. Directional information along with the expected shadowing effects associated with nearby body or car blockage could be used to perform split correlator searches targeted at acquiring satellites as close to a first pass as possible for their assumed signal level.

Acquiring more satellites on a first pass or a first few passes in the search sequence rather than requiring a large number of unnecessary passes to acquire lower level signals will have a direct impact on Time To First Fix (TTFF). Split searches could additionally incorporate specific knowledge of antenna performance for a tested design which could significantly improve the algorithms used to tailor the starting search level for each individual satellite in view. Models for antenna patterns may be added to SPS or GPS software simulations in order to estimate real world performance that would allow antenna aiding to be incorporated into a mobile device.

In a first embodiment of the present invention, a method of improving a time to first fix in a satellite positioning system (SPS) can include the steps of determining a heading of an SPS device, determining an estimated direction of peak antenna gain in relation to a plurality of satellites in view, and prioritizing acquisition attempts of a portion of satellites in view based on the estimated direction of peak antenna gain and in view of the heading of the SPS device. The method can further include the step of determining if the SPS device is in a pedestrian environment or a vehicular environment. The method can also include the step of performing a split search with correlators split between searches for satellites with assumed peak gain and satellites having a lower level of gain where a shorter dwell time is applied on the searches for satellite with assumed peak gain and a longer dwell time is applied on the searches for satellites with the lower level of gain. The method can further include electronically presenting an orientation guide to a user of the SPS device based on the estimated direction of peak antenna gain and in view of the heading of the SPS device. Determination of the heading can be enhanced by using a tilt determination, a compass heading determination, or an acceleration determination to further refine the heading. The method can also apply apriori known antenna gain performance values for a particular design.

In a second embodiment of the present invention, another method of improving a time to first fix in a satellite positioning system (SPS) can include the steps of retrieving GPS aiding information, determining a set of satellites in view with approximate azimuth and elevation values, retrieving a heading value, determining a satellite priority-split correlation, and performing a split correlator search based on the satellite priority-split correlation. As mentioned above, a split search can involve correlators split between searches for satellites with assumed peak gain and satellites having a lower level of gain where a shorter dwell time is applied on the searches for satellites with assumed peak gain and a longer dwell time is applied on the searches for satellites with the lower level of gain. How such a split is determined can be based on the satellite priority-split correlation among satellites in view and the assumed peak gain for such satellites. The method can further include determining if a minimum number of satellites are acquired and refreshing the heading value if the split correlator search fails to find the minimum number of satellite. Note, almanac information or ephemeris information can be used for the GPS aiding information and a compass heading value can be used for the heading value. The heading value can include direction of travel information and possible blockage information. The method can also further include applying apriori known antenna gain performance values for a particular design.

In a third embodiment of the present invention, a satellite positioning system (SPS) antenna aiding device includes an SPS receiver, an environmental sensor to determine a heading value, a tilt value, or an acceleration value, and a processor coupled to the SPS receiver and the environmental sensor. The processor can be any suitable component or combination of components, including any suitable hardware or software, that are capable of executing the processes described in relation to the inventive arrangements herein. The processor can be programmed to determine a heading of the SPS receiver (such as a tilt determination, a compass heading determination, or an acceleration determination to further refine the heading), determine an estimated direction of peak antenna gain in relation to a plurality of satellites in view, and prioritize acquisition attempts of a portion of satellites in view based on the estimated direction of peak antenna gain and in view of the heading of the SPS receiver. The processor can be further programmed to determine if the SPS receiver is in a pedestrian environment or a vehicular environment. The processor can also be programmed to perform a split search with correlators split between searches for satellites with assumed peak gain using a shorter dwell time and searches for satellites having a lower level of using a longer dwell time. The SPS antenna aiding device can also electronically present an orientation guide to a user of the SPS antenna aiding device based on the estimated direction of peak antenna gain and in view of the heading of the SPS receiver. The processor can also further apply apriori known antenna gain performance values for a particular design.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system. The term “heading” can indicate a direction in two or three dimensional space.

Other embodiments, when configured in accordance with the inventive arrangements disclosed herein, can include a system for performing and a machine readable storage for causing a machine to perform the various processes and methods disclosed herein.

### BRIEF DESCRIPTION OF THE DRAWINGS

FIG. 1 is a block diagram of a satellite positioning system (SPS) antenna aiding device in accordance with an embodiment of the present invention.

FIG. 2 is another is a “skyplot” of satellites in view in accordance with an embodiment of the present invention.

FIG. 3 is a method of improving a time to first fix in a satellite positioning system (SPS) in accordance with an embodiment of the present invention.

FIG. 4 is a plot of antenna gain characteristics in accordance with an embodiment of the present invention.

FIG. 5 is another plot of antenna gain characteristics in accordance with an embodiment of the present invention.

FIG. 6 is another skyplot that can be used in conjunction with the antenna gain characteristic plot of FIG. 4 or FIG. 5 to improve TTFF in accordance with an embodiment of the present invention.

FIG. 7 is a skyplot illustrating satellite positions in the sky relative to their azimuth and elevation in accordance with an embodiment of the present invention.

FIG. 8 is a sky plot illustrating the satellites in view from FIG. 7 in accordance with an embodiment of the present invention.

FIG. 9 is another skyplot illustrating the directional orientation a user would be prompted to make in accordance with an embodiment of the present invention.

FIG. 10 is another skyplot illustrating an initial examination of satellites in view as a user is facing west.

FIG. 11 is another skyplot illustrating a user selecting southeast as an optimal direction in accordance with an embodiment of the present invention.

FIG. 12 is an illustration of a top view for 2-axis accelerometer tilt sensing in accordance with an embodiment of the present invention.

FIG. 13 is a reference table demonstrating how reference tilt versus antenna gain can be populated with data measured in accordance with an embodiment of the present invention.

FIG. 14 is a flow chart illustrating a method of improving a time to first fix in a SPS system in accordance with an embodiment of the present invention.

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

Embodiments herein can generally improve time to first fix (TTFF) of satellite signal acquisition by antenna aiding. Antenna aiding itself in the embodiments herein can generally fall within two categories, but may not necessarily be limited thereto. In a first category, antenna aiding to a user can be used for optimal physical orientation (e.g. software in search engine may not have knowledge of physical orientation of the unit and does not adjust searches, but the user is given hints as to the best direction to face or angle of tilt to hold their handheld unit in order to maximize gain). In the second category, antenna aiding can be used to improve software correlation (e.g. user does not get the aiding and does not need to physically try to change their orientation to improve gain, but aiding using sensors or user input is used by software to help the search engine to determine which satellites might benefit from an optimized split correlator search)

In typical GPS applications in a mobile handheld device, antenna orientation is unknown and there are no optimization parameters available to a GPS search engine to account for antenna properties that are known to the product designer for a fixed antenna orientation. However, integration of a compass to feed heading information for the unit's current directional orientation or integration of other environmental sensors such as an accelerometer can provide feedback to the search engine that can prove valuable in selecting priority for which satellites in view to attempt acquisition on first.

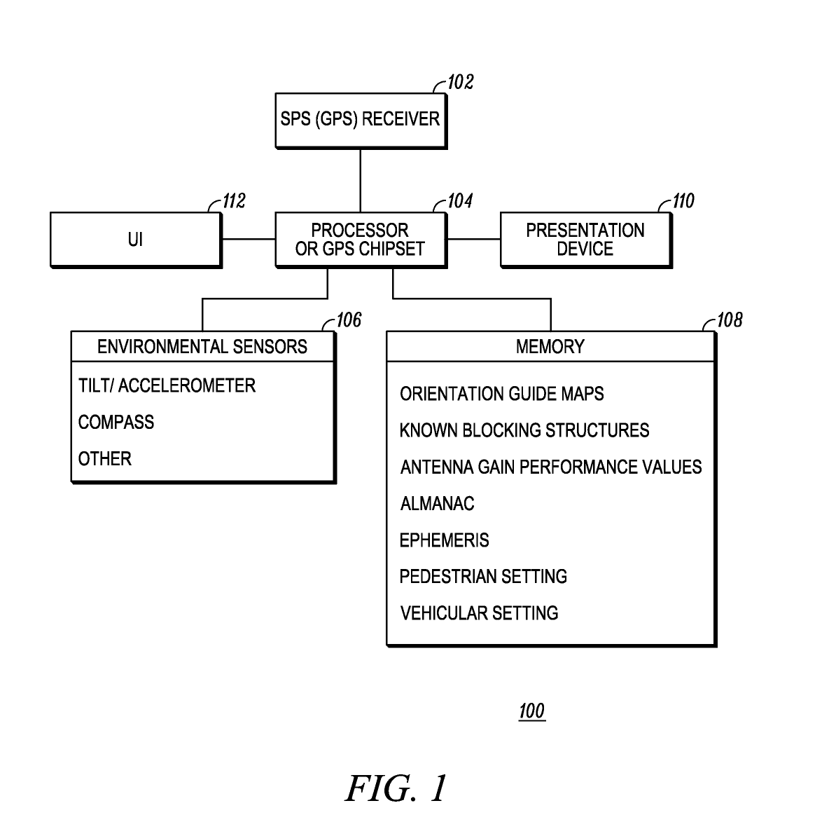

Additional information on user environment can be obtained from use of an accelerometer which is often combined with a magnetic compass for tilt compensation. Accelerometers additionally can measure speed of user motion, which can then be used to determine whether a user is traveling at a walking pace or in a car. Additional hints of that nature can in turn further optimize the best search algorithm for a particular user environment. A device such as a mobile handheld device 100 as shown in FIG. 1 can include an SPS or GPS receiver 102, environmental sensors 106, a memory 108, and a presentation device 110 coupled to a processor or GPS chipset 104. The device 100 can further include a user interface 112. The environmental sensors 106 can include a compass or accelerometer, but can include any other number of environmental sensor that can measure heading, tilt, location orotherfactors. The memory 108 can include orientation guide maps and a host of other information useful in accordance the embodiments. The orientation guide maps or other data can include information about known blocking structures. The memory can further store antenna gain performance values (for a particular device), Almanac information, ephemeris information, and other information or settings based on information gathered from the sensors 106.

GPS signal level has a correlation to antenna orientation. It is also known that proximity of nearby objects to an antenna can cause signal blockage. It is also well established that testing of handheld devices in different user positions such as dialing position held in a phantom hand or call position next to a phantom head will result in a reduction of the average gain of a GPS antenna (dBi) when viewed from an overhead sky view plane. This attenuation is related to detuning effects of the antenna due to nearby body blockage. Since gain in the direction of the body blockage may be reduced by 2-3 dB or more in certain positions since such direction will be an indirect path to receive satellite signals, it is intuitive that the average peak gain for antenna performance will lie in a direction away from the nearby body blockage. Navigating inside of a car also can add on-average an extra 5-8 dB of signal attenuation to satellites not in direct line of sight view through one of the windows due to the vehicle roof creating signal blockage.

GPS chipsets often use aiding parameters to help speed acquisition of satellite signals. These aiding parameters typically are constrained to TCXO frequency aid, location aid, GPS time aid, and ephemeris. Antenna aiding using other environmental parameters is not currently implemented on any handset and as such can provide possible gains in performance. GPS search engines typically will use a list of satellites in view estimated from an almanac or known precisely from ephemeris aid to determine which ones to emphasize in their searches in order to complete an acquisition. These searches are performed by dwelling in assigned search bins while trying to correlate on specific satellite codes. Dwell times will be short in the initial search phase when attempting to acquire high signal level satellites. In order to acquire satellites at lower signal levels, dwell times are progressively increased on each cycle of the search (e.g. after all search bins are progressed through at a short dwell time, then the cycle repeats with a slightly longer search time, and the sequence continues with TTFF progressively increasing as more levels of searches are performed.)

TTFF can directly be linked to signal level of the satellites used in the fix due to the way the searches are performed. Fully aided fixes with ephemeris from a network can take a minute or more to report at low signal level between 15-23 dB-Hz depending on system architecture and quality of other aiding parameters. Autonomous or partially aided fixes without ephemeris typically can take several minutes to report a fix and satellites below 30 dB-Hz usually can not be acquired.

Referring again to FIG. 1, an embodiment herein can include simply feeding the chipset or processor 104 the heading direction of the user based on the handset orientation as determined by the sensor(s) 106. The (GPS) search engine knows azimuth and elevation for the satellites in view and therefore can estimate that for satellites in a 180 degree plane in a right angle to the user heading there will be less blockage than from the user's body or from a car roof. In this manner, the chipset or processor 104 can estimate the direction of peak antenna gain. For example, if there are 8 satellites available in an open sky view, the chipset can then choose to prioritize acquisition attempts of the satellites in the direction of the estimated peak gain in order to speed TTFF. The term “peak antenna gain” can indicate the set of strongest signals received or best received for a particular antenna configuration, particularly as it relates to satellites in view for a device or alternatively as it relates to an orientation of the device relative to the satellites in view. This term can, but does not necessarily need to take into account blocking structures.

Additionally, if accelerometer information capable of reporting the speed of a user motion were incorporated, the chipset could estimate or make a best guess whether the user environment was in a car or or on foot. This information could be used to do a split search with the correlators. By splitting the search, a certain portion of the correlators can assume a peak gain in the heading direction and search for the satellites known to be in that area at a high signal level with short dwell times. The rest of the correlators would be assigned to jump their search directly to a longer dwell time assumed for the attenuation estimated by the user environment for the satellites in the direction of body or car blockage. Using this technique eliminates the time needed to perform several passes of attempted searches which would most likely be failures that add to overall TTFF. An example selection for attenuation parameters might assume 2-3 dB attenuation for body blockage alone and approximately 5-8 dB of attenuation in car blockage. Reducing search iterations required to acquire enough satellites to complete a full fix calculation (4 minimum) would be a positive impact on TTFF. If no information related to user motion were known, the split correlators search could still be used, but a body blockage model might be the assumed starting point for all cases.

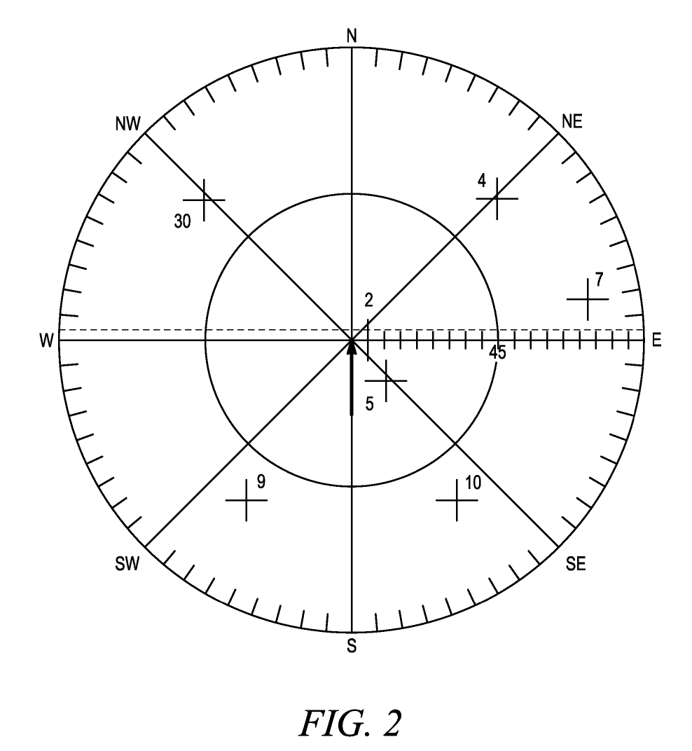

Embodiments herein can be pictorially demonstrated through use of “sky plots” as shown in FIG. 2 which show satellite positions in the sky relative to their azimuth and elevation which can also be viewed as compass directions. All compass directions are referenced to the center point of the graph which is the coarsely assumed location of the handset at the start of the search (typically the location broadcast as aiding from a nearby base station). The center of the sky plot in FIG. 1 is at the estimated user location. If a satellite were directly 90 degrees overhead, it would be shown at the center of the sky plot. The middle circle of the graph represents satellites at a 45 degree elevation. The outer circle is 0 degrees elevation and as satellites approach approximately 5-10 degrees elevation they will fall out of view from the user due to the earth's horizon in an open sky situation.

In the example of FIG. 2, with a user facing north as represented by the arrow, satellites 2 (almost overhead), 4, 7, and 30 would be assumed to have the least blockage from immediate user environment (body or car). Satellites 2 and 30 are expected to have a slightly higher signal level than satellites 4 and 7 that are at elevations shown closer to the horizon and obviously farther away from the user. Satellites 5, 9, and 10 would be assumed to be blocked or attenuated to some degree by the user's body or location in a car. A possible search strategy could be optimized as follows: satellites 30 and 2 are the first priority high level search, 4 and 7 while in the direction of peak gain are known to be at a lower signal level than satellites 30 and 2 by 1-2 dB due to propagation losses so split correlators search could drop several levels for their acquisition attempt, while 5, 9, and 10 would fall in the lowest category with either an assumed 2-3 dB of blockage or 5-8 dB depending on whether location is thought to be in car or not.

Therefore, several levels of dwell times for splitting between correlators can be chosen for assignment on a first pass search based on simple knowledge of user heading. While this cannot account for other surrounding blockage caused by buildings or geographic features, overall TTFF can be expected to be faster for this type of search algorithm, especially in an open sky environment (no obstructions).

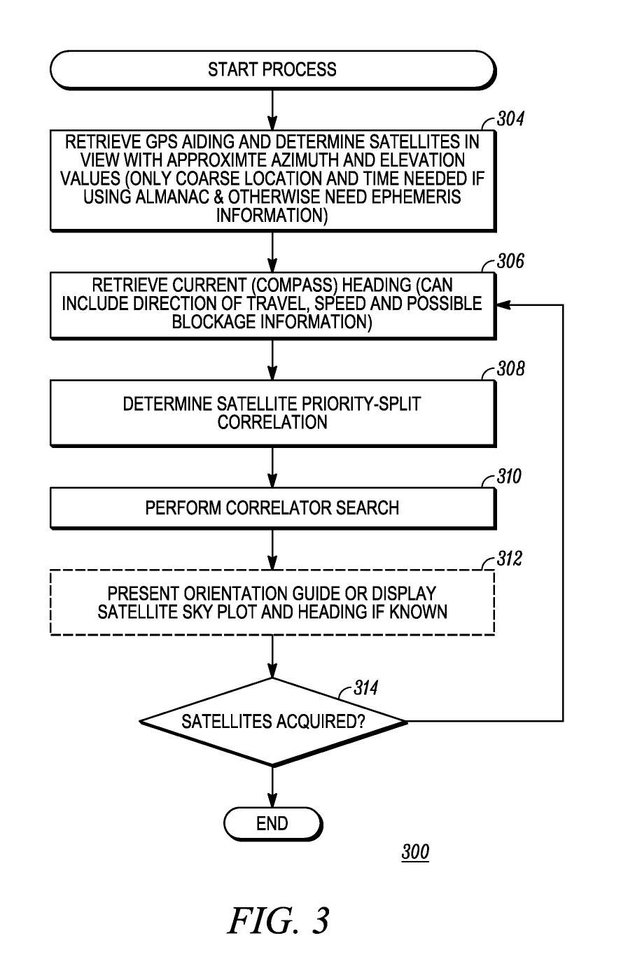

Referring to FIG. 3, a flow chart illustrating a method 300 of improving a time to first fix in a satellite positioning system (SPS) can include the step 304 of retrieving GPS aiding information and determining satellites in view with approximate azimuth and elevation values. The GPS aiding information can include, but is not necessarily limited to ephemeris, almanac, rough initial position, clock drift and time, satellite status and, if available, a precise time synchronization signal. Note only coarse location and time is needed if Almanac information is use and otherwise Ephemeris data can be used. The method 300 can further include the step 306 of determining a heading of an SPS device which can include determining an estimated direction of peak antenna gain in relation to a plurality of satellites in view and possible blockage information. In some embodiments, the heading information might optionally include speed information which can also be useful in determining certain blockage scenarios (e.g., pedestrian or automobile scenarios). The method 300 can further include the step 308 of determining a satellite priority-split correlation or in other words, prioritizing acquisition attempts of a portion of satellites in view based on the estimated direction of peak antenna gain and in view of the heading of the SPS device. The method can further include the step of determining if the SPS device is in a pedestrian environment or a vehicular environment. The method 300 can also include the step of performing a split search at step 310 with correlators split between searches for satellites with assumed peak gain and satellites having a lower level of gain where a shorter dwell time is applied on the searches for satellite with assumed peak gain and a longer dwell time is applied on the searches for satellites with the lower level of gain. The method can further optionally include electronically presenting at step 312 an orientation guide or a sky plot to a user of the SPS device based on the estimated direction of peak antenna gain and in view of the heading of the SPS device. Determination of the heading can be determined by a magnetic compass which may be combined with an accelerometer. An accelerometer may be used for tilt determination in order to electronically gimbal the compass for better accuracy. An accelerometer may also be used to estimate speed of user motion which may be used as an environmental hint to determine if the user is on foot or in a vehicle. The method can also apply apriori known antenna gain performance values for a particular design as will be further discussed below. In any event, the method can determine if the minimum number of satellites is acquired at decision block 314. If so, the method ends. If the minimum number of satellites is not acquired, the method returns to refresh the heading information at step 306 and continues with steps 308-314.

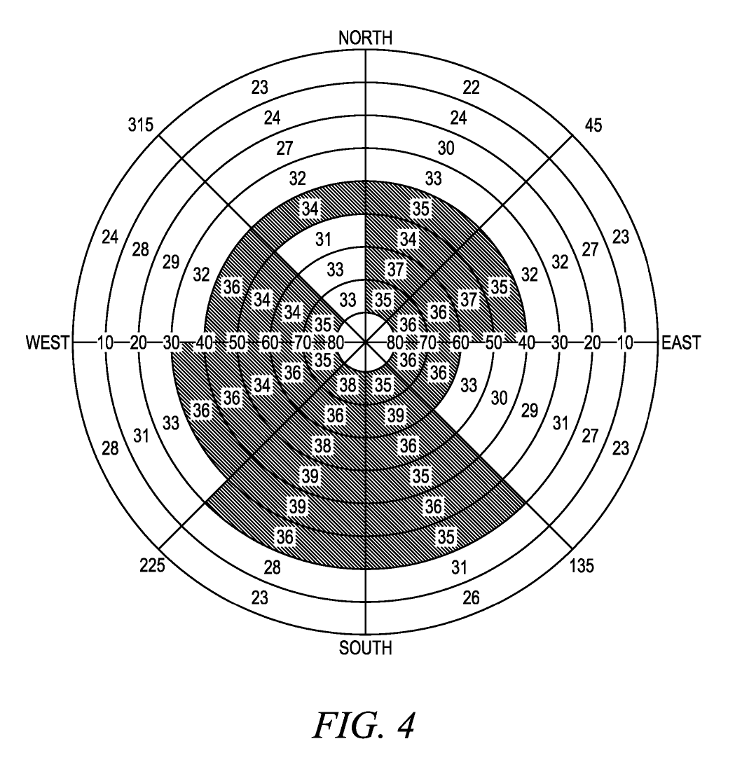

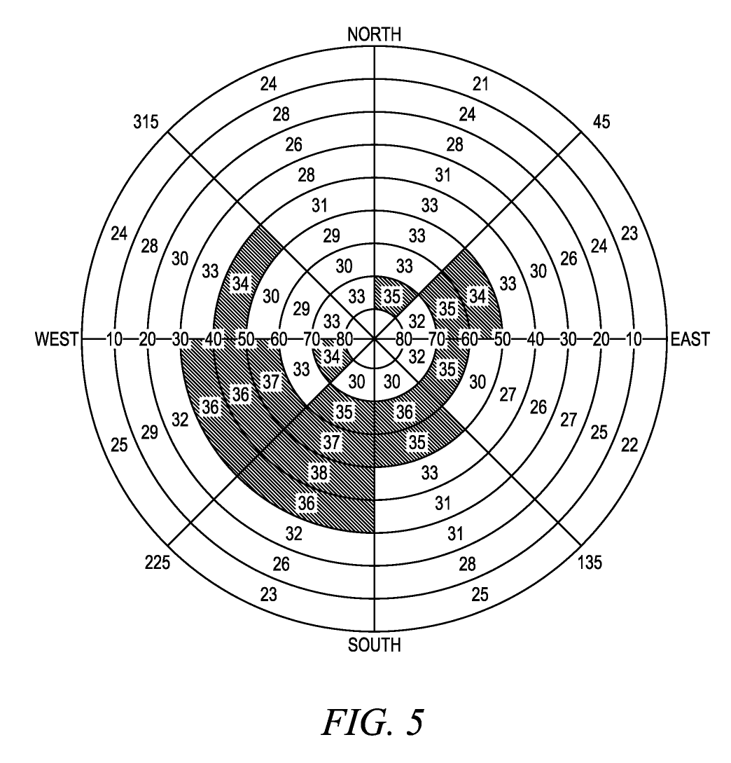

In an alternate implementation, a method and system herein can incorporate an overlay of known antenna gain performance values for a specific design combined with some or all of the steps of the process described above. The charts of FIGS. 4 and 5 demonstrate sample plots for varying antenna gain characteristics for two separate models of sample phones under evaluation by Motorola tested side by side continuously tracking satellites for 24 hours. Nearby body blockage is not accounted for in these plots as they were clamped into a relatively free space condition, but it is easily seen that there are several lobes in the pattern of one antenna that have higher gain than the other antenna. Antennas were tested in a south facing position which is supported by examination of the slightly higher antenna gain shown for satellites tracked in a southern quadrant of the plots. This data supports the hypothesis that overall antenna gain is slightly directional based on specific characteristics of a handset housing causing blockage that can affect gain by several dB in a certain direction. This assumption is clearly extended to blockage effects caused by a user's body while holding the handset.

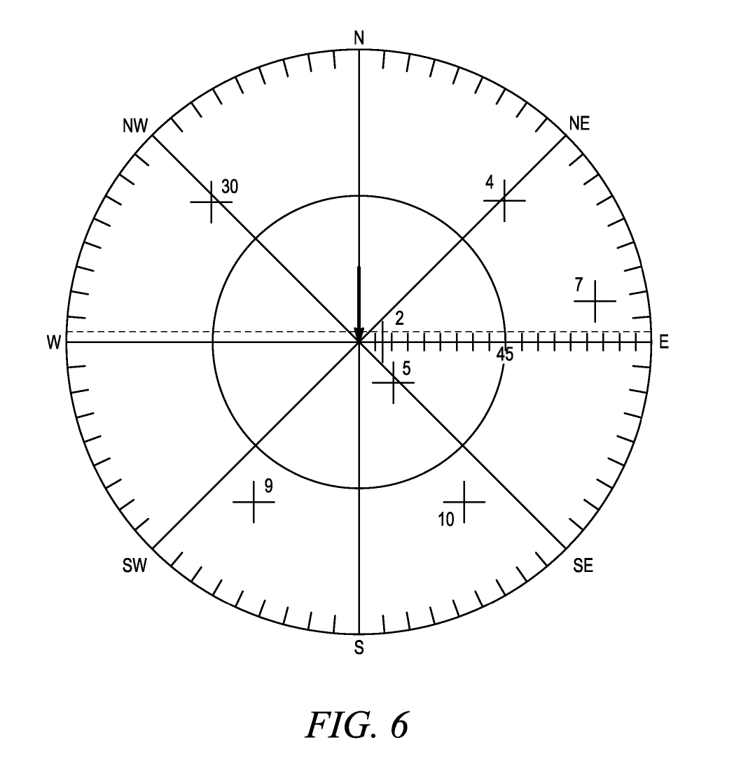

Knowledge of specific antenna pattern characteristics can be compared as an overlay to a sky plot as shown in FIG. 6 to further optimize the implementation of split correlator searches to tailor the starting search levels for each satellite in view. This can then include not only knowledge of blockage from a body or car, but also knowledge of gain on specific lobes of an antenna pattern. The user orientation in the sky plot of FIG. 6 is facing south to simplify comparison with the directionality of the antennas when the gain data was taken.

Satellites 2, 5, 9, and 10 in FIG. 6 fall into high gain search areas for both antenna types with somewhat flat gain expected for all of them with the antenna represented by FIG. 4, while the antenna represented by FIG. 5 would be expected to have 3-4 dB higher gain for Satellites 2 and 5 over the levels expected for 9 and 10. Satellites 4 and 7 due to their proximity to the horizon and the fact that they are not on the side of the housing that the antenna is facing might be 7-10 dB lower than the highest signal level in the southern quadrant. This is before body shadowing or car blockage is assumed. Examination of Satellite 30 versus the two antennas provides the most interesting result. The antenna represented by FIG. 4 would still be expected to have a relatively high gain response for satellite 30 even with several dB of body blockage assumed. The antenna represented by FIG. 5 exhibits a “hole” in the pattern with low gain in the northwest quadrant and again that satellite can fall approximately 8 dB below the max gain in the southern quadrant even before body or car blockage was considered. If 8 higher level passes of the search engine can be skipped to directly search for that particular satellite at a lower level, chances of acquiring it in a timely manner would increase and overall TTFF would be improved over a search that assumes all satellites are at the same level at the start.

Thus, users can obtain satellite fixes far more quickly if heading information about the user's current orientation were incorporated as part of an antenna aiding algorithm to an SPS or GPS search engine. Directional information along with the expected shadowing effects associated with nearby body or car blockage could be used to perform split correlator searches targeted at acquiring satellites as close to a first pass as possible for their assumed signal level. Acquiring more satellites on a “first pass” rather than requiring a large number of unnecessary passes to acquire lower level signals will have a direct impact on TTFF. Split searches could additionally incorporate specific knowledge of antenna performance for a tested design which could significantly improve the algorithms used to tailor the starting search level for each individual satellite in view.

GPS signal acquisition uses known characteristics of satellites in view in the sky to optimize searches and speed TTFF. In sessions where ephemeris is available by network aiding, a handheld unit will know the azimuth and elevation angle for all satellites in view at the beginning of a session. In sessions where GPS time and coarse location aiding are available by a network broadcast, the handheld unit can still estimate approximate azimuth and elevation for a list of satellites assumed to be in view at that location by referencing an almanac. Even in sessions where no starting information is known, the GPS software can begin to reference its almanac to estimate what other satellites may be in view once tracking of one satellite is established.

In fully aided sessions with low signal level, fixes may take a minute or more to report a location and this TTFF may increase to several minutes or more in autonomous sessions without ephemeris aid or with no aid at all. In all of these sessions, it is commonly known that there is a marked improvement in TTFF that can be established for an increase in the average signal strength (C/N) level of the satellites used to calculate the location fix of even a 2-3 dB gain over the minimum operating level. This is more noticeable in fixes without ephemeris aid because the signal level required for operation is much higher (30 dB-Hz C/N) than in an ephemeris aided case (15-23 dB-Hz depending on architecture of design).

Since signal level is critical to reporting fixes quickly and a few dB in gain can make the difference between whether a fix is successfully acquired or not, methods to interact with a user to help them optimize the directional pointing of their antenna during a GPS session can be beneficial. Such user aiding can most directly apply to initialization of the first fix acquired during any Location Based Service (LBS) session when a unit may need help during initial acquisition and then is able to track at lower signal levels thereafter once a session is established. Using visual cues relating readily available information on the satellites currently in view can help a user determine how best to orient their unit to acquire a fix as quickly as possible. Aiding a user to help him or her improve physical antenna orientation can be an alternate implementation to a split correlator approach. Aiding using a split correlator as previously discussed, would likely be built into the software code of a mobile device at a very low level in order to be used. Aiding to the user could be used with any product already on the market that has standard search processes and does not necessarily require software modifications to the existing search processing software. The aiding is intended to help the user orient their phone to physically maximize signal level (with compass direction so the user can turn in the direction with the most satellites in view or tilt orientation so the antenna is not getting bad multipath from pointing at the ground) and satellites with higher signal levels are acquired faster and thereby improving TTFF.

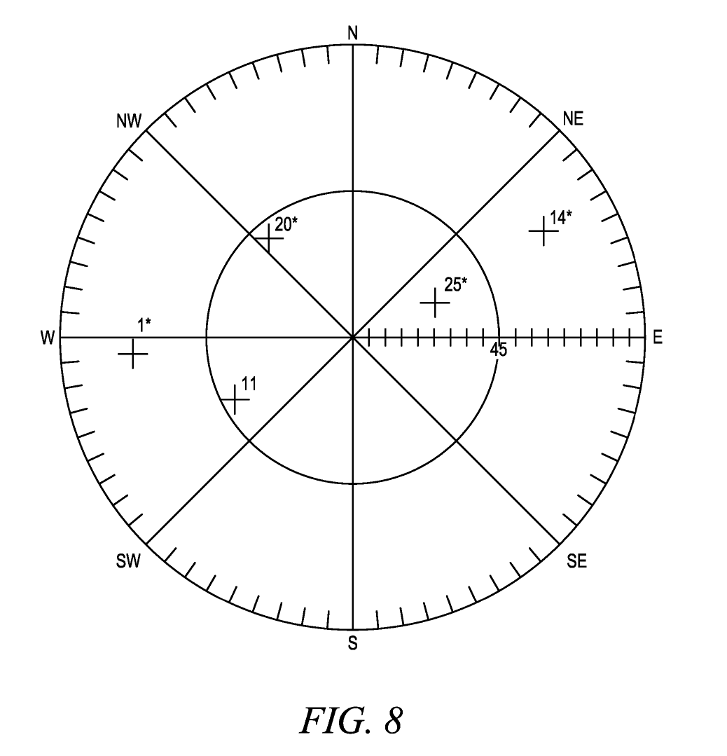

Once again using sky plots as shown in FIGS. 8 though 11, satellite positions in the sky relative to their azimuth and elevation can also be viewed as compass directions. All compass directions are referenced to the center point of the graph which is the coarsely assumed location of a handset at the start of a search (typically the location broadcast as aiding from a nearby base station).

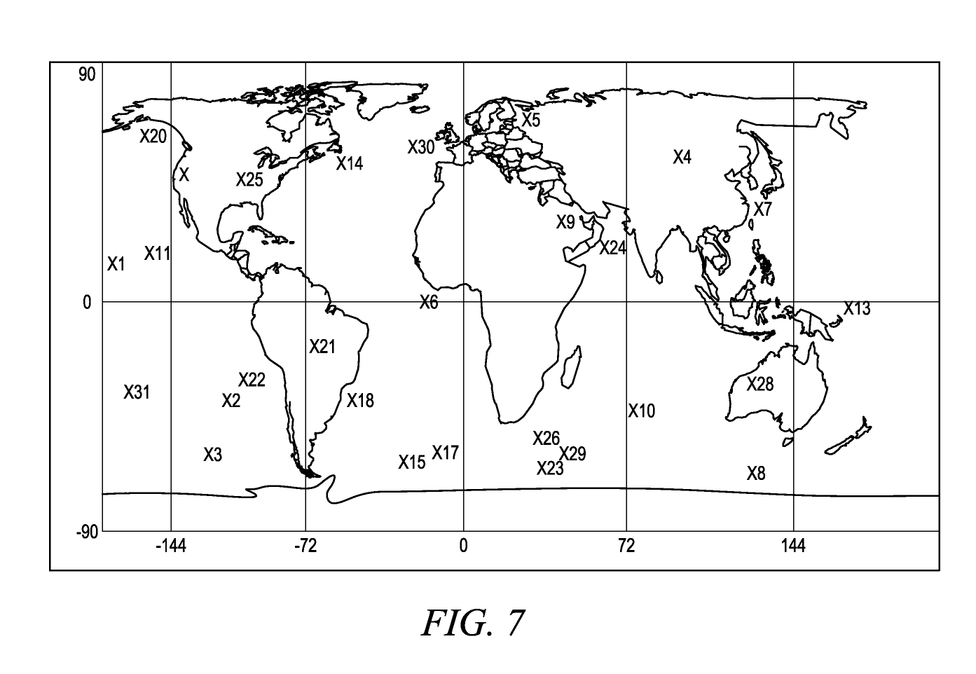

Referring to FIG. 7, an example set of satellites in view for a Spirent simulation created for Feb. 1, 2005 at midnight is illustrated. A user location can be on the west coast of North America at Latitude 37 and Longitude 122 (shown by the x that does not have a satellite number listed).

Referring to FIG. 8, the chart shown illustrates how the earth view of the satellites corresponds to a “sky plot.” The center of the sky plot is at the user location. If a satellite were directly 90 degrees overhead, it would be shown at the center of the sky plot. As noted previously, the middle circle of the graph represents satellites at a 45 degree elevation. The outer circle is 0 degrees elevation and as satellites approach approximately 5-10 degrees elevation they will fall out of view from the user due to the earth's horizon in an open sky situation.

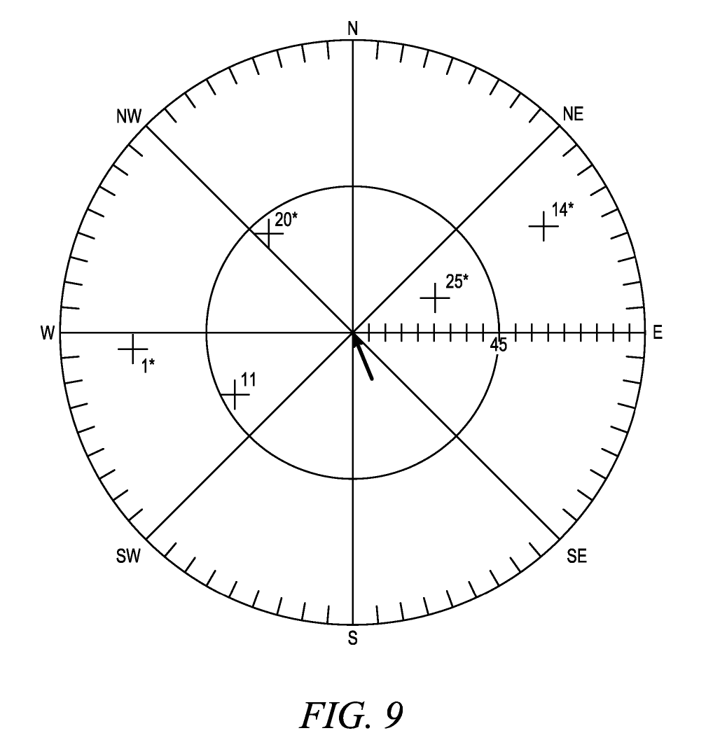

Referring to FIG. 9, the directional orientation decision a user can be prompted to make is illustrated if they were pictorially presented with a sky plot view on their handheld device of the satellites currently available at the start of their GPS session. It is clear from the arrangement of the satellites that a user would want to place their body (or blockage from their body while holding the device) in a SSE or SE direction relative to the device since there are no satellites in view there. This would place peak gain of the GPS antenna (at the front and sides of a user holding their handheld unit) facing in the direction of the satellites in view. Directional orientation can be completed by a user referencing visual clues such as direction of the sun or by integration of a compass in the handheld device.

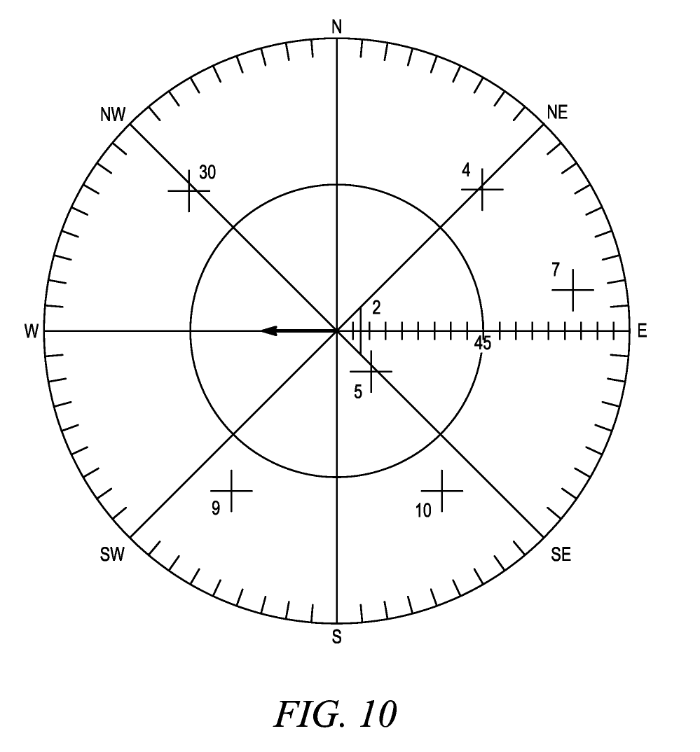

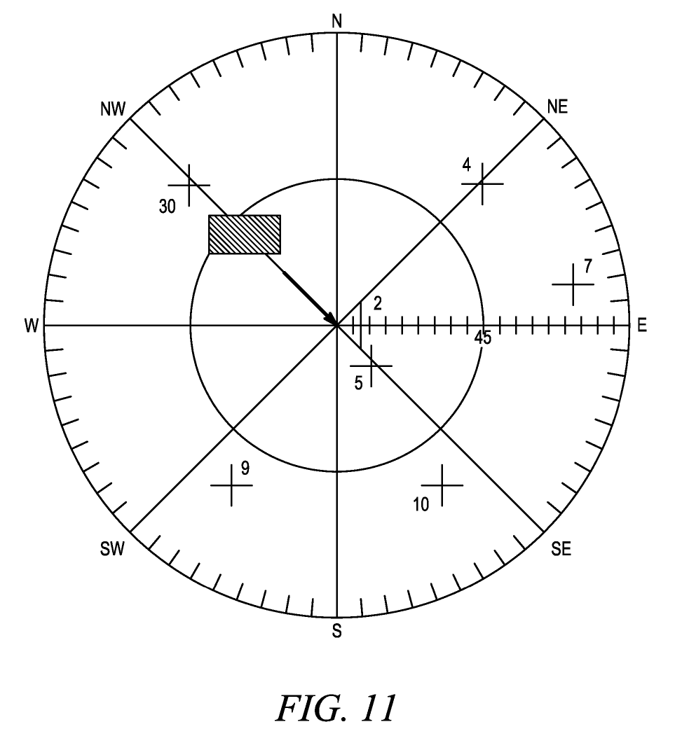

Pictorially on a handset screen, a unit with an integrated compass can automatically indicate a user's starting position relative to the satellites known to be in view at the start of a fix session. The sky plots in FIGS. 10 and 11 can illustrate how they can be used to as part of a user's decision making process when evaluating the best direction to face during their GPS fix attempt. In FIG. 10, a set of satellites in view for a Jun. 10, 2006 simulation occurring at 10 AM at 37-121 Latitude and Longitude is shown. A user begins the session facing west. Initial examination of the satellites in view would show that facing either SE or SW may be the best positions to place peak antenna gain towards the largest number of satellites in view. It might be assumed in an open sky situation that facing SW could be chosen as the optimal direction since satellite 30 is slightly higher in the sky than satellites 4 and 10 which are closer to the horizon. However, a user can also examine nearby blockage from buildings or geographic features like mountains as illustrated in FIG. 11 that may make one direction more preferable to another before making their final decision. Thus, FIG. 11 shows the user's final decision to face SE based on a building providing blockage to the NW with open sky views in other directions.

Users may be able to get fixes more often and in more locations if the handset were able to aid them on orientation needed to receive the best antenna gain. This gain can be optimized for the satellites currently in view through use of relating compass directionality for the user's heading and a visual aid such as a sky plot shown on the handset screen. Information needed to generate a satellite sky plot (azimuth and elevations of the satellites in view) is readily available by referencing a GPS almanac if coarse location and time are known. This satellite information is also readily available in ephemeris aiding provided to a handset by (assisted GPS) AGPS capable networks. User heading may roughly be estimated by user entry or more precisely estimated by use of an integrated compass in the handset. Achieving faster fixes by better antenna gain optimization can have an impact with a better TTFF and perceived better reliability by the user.

In yet another aspect of the invention, other environmental sensors can be used similarly to an improve upon TTFF. In typical GPS applications in a mobile handheld device, antenna orientation is left to the user with no interface to provide optimization hints that may increase signal gain. However, integration of an accelerometer as a tilt sensor could allow the user interface to provide interactive aiding which could result in a more optimal signal gain orientation that could improve the chances of achieving a fix and decrease TTFF.

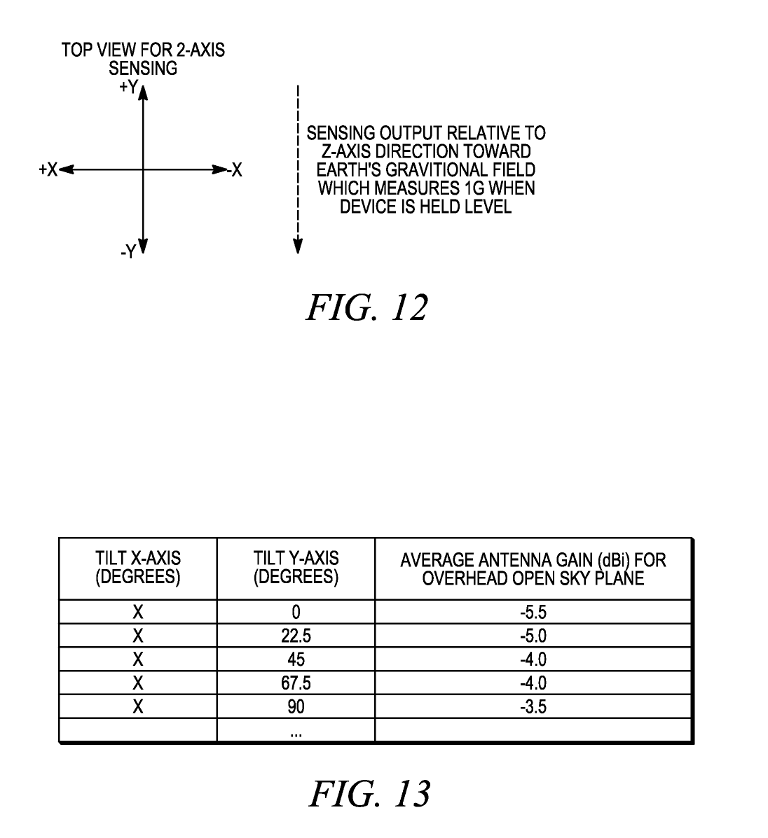

Accelerometers are typically small micro-machined devices that are capable of sensing tilt or inclination relative to the earth's gravitational field as well as inertial forces, shock, and vibration. MEMS accelerometers are an excellent option for space conservative handheld device implementations as they are low cost, surface mountable, require little board space (5×5 or 6×6 mm in a typical package size), have low operating current, and are multi-purpose in functionality that could enhance many features within the mobile device. A two-axis accelerometer can sense positive and negative tilt in XY directions relative to the earth's gravitational field as illustrated in FIG. 12. A level position for the device would nominally be zero tilt.

Tilt sensing can be implemented as an antenna aiding function for a GPS chipset to tell a user whether they are holding their unit in a sub-optimal position which may affect signal gain adversely. This could be of benefit to any antenna type, but most especially for an antenna with strong directional characteristics. As noted previously, an antenna improperly pointed could have a 2-3 dB affect on gain in a typical handheld device due to indirect signal paths (multipath) affecting acquisition.

Gain of an antenna is typically measured in the design phase of a product. This approach can implement a simple table of degrees of tilt increments versus expected average gain in dBi for the antenna in that orientation as illustrated in FIG. 13. This will create a decision matrix of tilt ranges where gain versus orientation is acceptable or whether it should be adjusted if a user desires to improve performance. If orientation is determined to be suboptimal, then a message can be displayed to the user to suggest how they might adjust their tilt orientation to get better results. In this manner, a user's antenna can have a better view of the sky relative to the satellites in view in a normal use case which should result in a more direct line of sight for receiving low level GPS signals.

The typical received signal for GPS at the air interface of an antenna is approximately in the range of −125 to −130 dBm in open sky situations with no signal blockage and can be in the range of −150 dBm or lower for indoor situations. At low signal levels such as this, it is highly beneficial for the TTFF for reporting a location fix where the received signal has as little attenuation as possible. This is even more important in autonomous operational cases where no ephemeris aiding is provided from a network which means that no fixes can be achieved below a C/No level of 30 dB-Hz. In an ephemeris aided case a fix may be obtained at levels of 23 dB-Hz or lower.

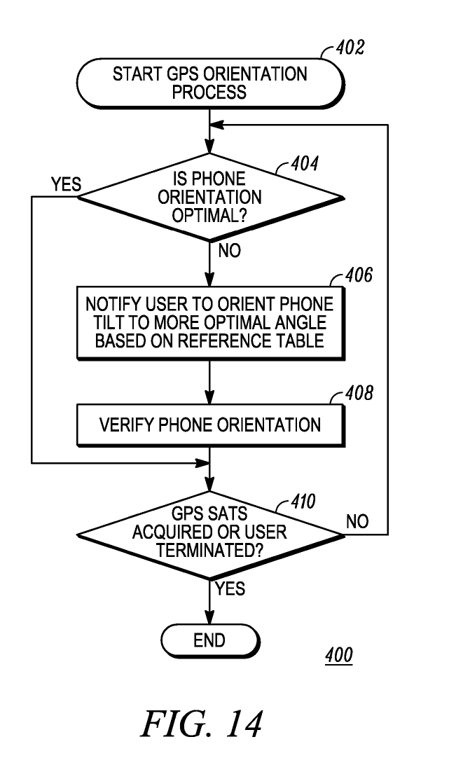

Referring to FIG. 14, a flow chart of a possible decision process 400 for using a tilt versus gain table while attempting to acquire satellites during a GPS session is shown. At step 402, the GPS orientation process is started and a determination is made at decision block 404 if the device (such as a phone) is in an optimal orientation. If the device is in an optimal position, a determination is made if all GPS satellite are acquired at decision block 410. If the orientation is less than optimal at decision block 404, the user is notified at step 406 to tilt the device in a more optimal angle based on the reference table. The phone orientation can then be verified at step 408. If all the appropriate GPS satellites are acquired or the user terminates the function at decision block 410, then process can end.

Lower signal gain is known to have a direct impact on TTFF. Achieving faster fixes by better antenna gain optimization can have an impact in a perceived better reliability by the user. Users may be able to get fixes more often and in more locations if the handset were able to aid them on orientation needed to receive the best antenna gain through use of an accelerometer.

In light of the foregoing description, it should be recognized that embodiments in accordance with the present invention can be realized in hardware, software, or a combination of hardware and software. A network or system according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. A method of improving a time to first fix in a satellite positioning system (SPS), comprising the steps of:
determining a heading of an SPS device;
determining an estimated direction of peak antenna gain in relation to a plurality of satellites in view; and
prioritizing acquisition attempts of a portion of satellites in view based on the estimated direction of peak antenna gain and in view of the heading of the SPS device.

2. The method of claim 1, wherein the method further comprises the step of determining if the SPS device is in a pedestrian environment or a vehicular environment.

3. The method of claim 1, wherein the method further comprises the step of performing a split search with correlators split between searches for satellites with assumed peak gain and satellites having a lower level of gain.

4. The method of claim 3, wherein the method further comprises the steps of applying a shorter dwell time on the searches for satellite with assumed peak gain and applying a longer dwell time on the searches for satellites with the lower level of gain.

5. The method of claim 1, wherein the method further comprises the step electronically presenting an orientation guide to a user of the SPS device based on the estimated direction of peak antenna gain and in view of the heading of the SPS device.

6. The method of claim 1, wherein the step of determining the heading comprises using a magnetic compass, or a magnetic compass combined with an accelerometer to further refine the heading.

7. The method of claim 1, wherein the method further comprises the step of applying apriori known antenna gain performance values for a particular design.

8. A method of improving a time to first fix in a satellite positioning system (SPS), comprising the steps of:
retrieving GPS aiding information;
determining a set of satellites in view with approximate azimuth and elevation values;
retrieving a heading value;
determining a satellite priority-split correlation; and
performing a split correlator search based on the satellite priority-split correlation.

9. The method of claim 8, wherein the method further comprises the step of determining if a minimum number of satellites are acquired and refreshing the heading value if the split correlator search fails to find the minimum number of satellites.

10. The method of claim 8, wherein the method further comprises the step of using almanac information for the GPS aiding information.

11. The method of claim 8, wherein the method further comprises the step of using ephemeris information for the GPS aiding information.

12. The method of claim 8, wherein the heading value comprises a compass heading value.

13. The method of claim 12, wherein the heading value comprises direction of travel information and possible blockage information.

14. The method of claim 8, wherein the method further comprises the step of applying apriori known antenna gain performance values for a particular design.

15. A satellite positioning system (SPS) antenna aiding device, comprising:
an SPS receiver;
an environmental sensor to determine a heading value, a tilt value, or an acceleration value; and
a processor coupled to the SPS receiver and the environmental sensor, wherein the processor is programmed to:
determine a heading of the SPS receiver;
determine an estimated direction of peak antenna gain in relation to a plurality of satellites in view; and
prioritize acquisition attempts of a portion of satellites in view based on the estimated direction of peak antenna gain and in view of the heading of the SPS receiver.

16. The SPS antenna aiding device of claim 15, wherein the processor is further programmed to determine if the SPS receiver is in a pedestrian environment or an vehicular environment.

17. The SPS antenna aiding device of claim 15, wherein the processor is further programmed to perform a split search with correlators split between searches for satellites with assumed peak gain using a shorter dwell time and searches for satellites having a lower level of using a longer dwell time.

18. The SPS antenna aiding device of claim 15, wherein the processor is further programmed to electronically present an orientation guide to a user of the SPS antenna aiding device based on the estimated direction of peak antenna gain and in view of the heading of the SPS receiver.

19. The SPS antenna aiding device of claim 15, wherein the processor is further programmed to determine the heading using a tilt determination, a compass heading determination, or an acceleration determination to further refine the heading.

20. The SPS antenna aiding device of claim 15, wherein the processor is further programmed to apply apriori known antenna gain performance values for a particular design.
